(19) United States
(12) Patent Application Publication
(10) Pub. No.: US 2005/0136242 A1
(43) Pub. Date: Jun. 23, 2005

(54) Porous substrates having one side treated at a higher concentration and methods of treating porous substrates

(75) Inventors: Ali Yahiaoui, Roswell, GA (US); Lisa Larae Bushman, Kaukauna, WI (US); Brandi Mobley, Vernon Hills, IL (US)

Correspondence Address: KIMBERLY-CLARK WORLDWIDE, INC., 401 NORTH LAKE STREET, NEENAH, WI, 54956, US

(73) Assignee: Kimberly-Clark Worldwide, Inc.

(21) Appl. No.: 10/743,893

(22) Filed: Dec. 22, 2003

(51) Int. Cl. B32B 3/26

(52) U.S. Cl. 428/317.9; 428/310.5; 428/543

(57) ABSTRACT

The present invention provides a method of treating a porous substrate that includes contacting a surfactant or a mixture of surfactants to a surface of the porous substrate such that opposite surface of the porous substrate contacts a lesser amount of the surfactant or mixture of surfactants than the first surface contacts. The present invention also provides a porous, treated substrate that includes a first surface that includes a first amount of a surfactant or mixture of surfactants and a second surface that includes a lesser amount of the surfactant or the mixture of surfactants.

### CROSS-REFERENCE TO RELATED APPLICATIONS

This application is related to commonly assigned U.S. patent application Ser. No. ______, entitled “TREATED NONWOVEN MATERIAL” filed by Express Mail Procedure EL 439721075 US contemporaneously herewith and which is hereby incorporated by reference herein.

### FIELD

The present invention relates methods for treating nonwoven fabrics and other substrates and treated nonwoven fabrics and other substrates.

### BACKGROUND

Polymers are used extensively to make a variety of products which include blown and cast films, extruded sheets, injection molded articles, foams, blow molded articles, extruded pipe, monofilaments, fibers and nonwoven webs. Some polymers, such as polyolefins, are naturally hydrophobic, and for many uses this property is a disadvantage. There are a number of uses for polymers where their hydrophobic nature either limits their usefulness or requires some effort to modify the surface characteristics of the shaped articles made therefrom. By way of example, polyolefins, such as polyethylene and polypropylene, are used to manufacture polymeric fabrics which are employed in the construction of such disposable absorbent articles as diapers, feminine care products, incontinence products, training pants, wipes, and so forth. Such polymeric fabrics are often nonwoven webs prepared by, for example, such processes as melt-blowing, carding, coforming and spunbonding. Frequently, such polymeric fabrics need to be wettable by water or aqueous-based liquids. Wettability may be obtained by spraying or otherwise coating (i.e., surface treating or topically treating) the fabric with a surfactant solution during or after its formation, and then drying the web.

Water-absorbent articles, especially personal care absorbent articles, such as diapers, training pants, sanitary napkins and incontinence products, typically include at least one nonwoven polymeric fabric. Polyolefin nonwoven fabrics and other types of polymeric fabrics are normally hydrophobic. Thus, to effectively absorb fluid the polymeric fabrics must be treated to become hydrophilic. In addition, it is desirable that the hydrophilic treatment promotes a drier environment by reducing and controlling moisture dampness in an enclosed or occlusive environment as during diaper wear. Skin moisture is a major source of skin health problems associated with the use of diapers that do not effectively maintain a dry environment at the material/skin interface. Accordingly, there is a need to improve the hydrophilicity or wettability of fibers, nonwoven fabrics and other substrates and to impart superior absorbent functions to a diaper and, desirably, promote a dryer environment within a diaper, particularly to substrates in a diaper that will be used not in direct contact to the skin of a wearer. There is also a need to minimize the amount of additives that are used to improve hydrophilicity and to limit the contact of the additives with the skin of wearer.

### SUMMARY

One aspect of the present invention is generally directed to a porous, treated substrate that includes a first surface that includes a first amount of a surfactant or mixture of surfactants and a second surface that includes a second amount of the surfactant or the mixture of surfactants wherein the amount of the surfactant or the mixture of surfactants on the second surface is less than the amount of the surfactant or the mixture of surfactants on the first side. Thus, the present invention provides a single layer nonwoven substrate that is treated more on one side than on the other side. Desirably, the single layer nonwoven substrate is treated predominantly more on one side than on the other side. More desirably, the single layer nonwoven substrate is treated on one side and virtually untreated on the other side. For example, the single layer nonwoven substrate may include greater than 0.18 weight percent of a surfactant or a combination of surfactants on one side and less than 0.15 weight percent of a surfactant or a combination of surfactants on the other side. Such substrates may exhibit improved fluid intake as measured by the Fluid Strikethrough test (Test Method EDANA 150.1-90) and minimize skin hydration as measured by Transepidermal Water Loss (TEWL) when used as a liner in a diaper or other absorbent product.

In certain embodiments, the porous, treated substrate is a thermoplastic porous, treated substrate. For example, the porous, treated substrate may be a thermoplastic porous, treated substrate where the thermoplastic is selected from the group consisting of polyolefins, particularly polymers and copolymers of ethylene and polymers and copolymers of propylene and combinations thereof. In certain embodiments, the porous, treated substrate is a single layer of film, a single layer of porous film, an apertured film, a single layer of nonwoven fabric or a single layer of foam. In one desirable embodiment, the porous, treated substrate is a single layer of spunbond nonwoven fabric that has a basis weight ranging from about 10 grams per square meter to about 50 grams per square meter. In certain embodiments, the surfactant or the mixture of surfactants is selected from the group consisting of ethoxylated, hydrogenated castor oil; sorbitan monooleate; ethoxylated polyalkyl siloxanes; an alkyl polyglycosides, derivatives of an alkyl polyglycosides and mixtures thereof. Desirably, the surfactant or the mixture of surfactants includes an ethoxylated, hydrogenated castor oil; sorbitan monooleate; and an alkyl polyglycoside or a derivative of an alkyl polyglycosides In certain embodiments, the first surface includes at least about 0.10 percent of the surfactant or the mixture of surfactants and the second surface includes less than about 0.05 percent of the surfactant or the mixture of surfactants. Desirably, the second surface includes essentially no surfactant. More desirably, the second surface includes no surfactant. A porous, treated substrate of the present invention may be used as a liner in a personal care absorbent article such as a diaper, particularly as a body side liner.

Another aspect of the present invention is generally directed to a method of treating a porous substrate that includes providing a porous substrate and contacting a surfactant or a mixture of surfactants to a surface of the porous substrate such that opposite surface of the porous substrate contacts a lesser amount of the surfactant or mixture of surfactants than the first surface contacts. The method results in less surfactant adhering to the second surface than the first surface. In certain embodiments, the step of contacting a surfactant or a mixture of surfactants to the first surface of the substrate includes contacting a foam that comprises the surfactant or mixture of surfactants to the first surface. Desirably, the ratio of the air volume to the liquid volume of the foam is about 50:1 and the foam is or includes an aqueous solution, dispersion or emulsion that comprises greater than about 10 weight percent of the surfactant or mixture of surfactants or other desired ingredients such as skin health ingredients, emollients, preservatives, vitamins, anti-oxidants, etc. In certain embodiments, the surfactant or a mixture of surfactants is contacted to the porous substrate at a rate of less than about 0.5 weight percent of the surfactant or mixture of surfactants relative to the weight of the porous substrate. In certain embodiments, the aqueous solution, dispersion or emulsion of the surfactant or mixture of surfactants has a viscosity of greater than about 10 cps. In certain embodiments, the method further includes bending the porous substrate in a second direction around an apparatus to define a wrap angle of from about 90° to 180° and contacting the surfactant or mixture of surfactants to the first surface of the porous substrate at about the point the porous substrate bends around the apparatus. More desirably, the wrap angle ranges from about 120° to 180° and, even more desirably, the wrap angle ranges from about 150° to 170°. In certain embodiments, the method further includes drying the porous, treated substrate by directing a gas, particularly heated air, at the substrate in a direction that is generally from the second surface toward the first surface. The method further includes drying the porous substrate with heated air impinging at much higher velocity on the second surface than on the first surface.

Yet another aspect of the present invention is directed to a combination of: a porous, treated substrate comprising a first surface that includes a first amount of a surfactant or mixture of surfactants and a second surface that includes a lesser amount of the surfactant or the mixture of surfactants; and a layer of nonwoven fibers comprising fibers treated with a polysaccharide, a modified polysaccharide, a derivative of a polysaccharide or a derivative of a modified polysaccharide. In certain embodiments, the second surface of the porous, treated substrate further may also include a skin health agent. In certain embodiments, the one or more layers of nonwoven fibers treated with a polysaccharide, a modified polysaccharide, a derivative of a polysaccharide or a derivative of a modified polysaccharide is a spunbonded web treated with ethyl hydroxyethyl cellulose, hydroxypropyl cellulose or a mixture thereof. Desirably, in certain embodiments the TEWL of the combination of the one sided, treated liner and the layer of nonwoven fibers treated with a polysaccharide is less than the TEWL of the porous, treated substrate and the layer of nonwoven fibers.

Other features and aspects of the present invention are discussed in greater detail below.

### BRIEF DESCRIPTION OF THE DRAWINGS

A full and enabling disclosure of the present invention, including the best mode thereof to one of ordinary skill in the art, is set forth more particularly in the remainder of the specification, including reference to the accompanying figures in which:

FIG. 1 illustrates an exemplary process for application of a treatment composition to a substrate.

FIG. 1A illustrates a contact angle in an exemplary process.

FIG. 2 illustrates another exemplary process for application of a treatment composition to a substrate.

FIG. 3 schematically illustrates an exemplary foam treatment application system that provides zoned or full width application.

FIG. 4 illustrates an exemplary zoned treatment application apparatus and system.

FIG. 5 illustrates a partially cutaway, top plan view of an exemplary absorbent article.

FIG. 6 illustrates a sectional view of the absorbent article of FIG. 5 taken along line 6-6.

Repeated use of reference characters in the present specification and drawings is intended to represent same or analogous features or elements of the present invention.

Test Methods

Skin Hydration Test

Skin hydration values are determined by measuring TransEpidermal Water Loss (TEWL) and can be determined by employing the following test procedure. The test is conducted on adults on the forearm, specifically an adult woman's forearm. Any medications should be reviewed to ensure they have no effect on test results and the subject's forearms should be free of any skin conditions such as rashes or abrasions. Subjects should relax in the test environment, which should be at about 72° F. (22° C.) with a humidity of about 40 percent, for about 15 minutes prior to testing and movement should be kept to a minimum during testing. Subjects should wear short sleeve shirts, not bathe or shower for about 2 hours before testing, and should not apply any perfumes, lotions, powders, etc., to the forearm.

The measurements are taken with an evaporimeter, such as a DERMALAB® instrument distributed by Cortex Technology, Textilvaenget 1 9560 Hadsund Denmark.

A baseline reading should be taken on the subject's midvolar forearm and should be less than 10 g/m²/hr. Each test measurement is taken over a period of two minutes with TEWL values taken once per second (a total of 120 TEWL values).

The end of a dispensing tube is placed on the mid-forearm for carrying out the test. The eye of the tube should be facing the target loading zone. A product to be tested is placed on the subject's forearm directly over the end of the tube. The product may vary depending upon the type of material to be tested or material availability so care should be taken to ensure that test results are comparable. A stretchable net such as that available from, Sturgilast Tublar Elastic Dressing Retainer Western Medical should be placed over the product to help to hold it in place.

Three equal loadings of 70 ml of 0.9 weight percent of NaCl aqueous solution available from VWR Scientific Products at about 95° F.+/−5° F. (35° C.) are delivered to the product at an interval of 45 seconds at a rate of 300 mils/minute by a pump such as a MASTERFLEX LS® pump. After 60 minutes, the product is removed from the subject's forearm and Evaporimeter readings taken immediately on the skin at the subjects midvolar forearm where the product had been. TransEpidermal Water Loss values are reported as the difference between the one hour and baseline values in g/m²/hr.

Water Vapor Transmission Rate Test

A suitable technique for determining the WVTR (water vapor transmission rate) value of a material is the test procedure standardized by INDA (Association of the Nonwoven Fabrics Industry), number IST 70.4 (99), entitled “STANDARD TEST METHOD FOR WATER VAPOR TRANSMISSION RATE THROUGH NONWOVEN AND PLASTIC FILM USING A GUARD FILM AND VAPOR PRESSURE SENSOR” which is incorporated by reference herein. The INDA procedure provides for the determination of WVTR, the permeance of the film to water vapor and, for homogeneous materials, water vapor permeability coefficient.

The INDA test method is well known and will not be set forth in detail herein. However, the test procedure is summarized as follows. A dry chamber is separated from a wet chamber of known temperature and humidity by a permanent guard film and the sample material to be tested. The purpose of the guard film is to define a definite air gap and to quiet or still the air in the air gap while the air gap is characterized. The dry chamber, guard film, and the wet chamber make up a diffusion cell in which the test film is sealed. The sample holder is known as the Permatran-W model 100K manufactured by Mocon/Modern Controls, Inc, Minneapolis, Minn. A first test is made of the WVTR of the guard film and air gap between an evaporator assembly that generates 100 percent relative humidity. Water vapor diffuses through the air gap and the guard film and then mixes with a dry gas flow which is proportional to water vapor concentration. The electrical signal is routed to a computer for processing. The computer calculates the transmission rate of the air gap and guard film and stores the value for further use.

The transmission rate of the guard film and air gap is stored in the computer as CalC. The sample material is then sealed in the test cell. Again, water vapor diffuses through the air gap to the guard film and the test material and then mixes with a dry gas flow that sweeps the test material. Also, again, this mixture is carried to the vapor sensor. The computer then calculates the transmission rate of the combination of the air gap, the guard film, and the test material. This information is then used to calculate the transmission rate in units of grams/square meter/24 hours (g/m²/24 hr) at which moisture is transmitted through the test material.

### DETAILED DESCRIPTION

Reference now will be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment, can be used on another embodiment to yield a still further embodiment. Thus, it is intended that the present invention cover such modifications and variations as come within the scope of the appended claims and their equivalents.

In general, one aspect of the present invention is generally directed to a method for treating a porous substrate that includes providing a porous substrate and contacting a surfactant or a mixture of surfactants to a surface of the porous substrate such that opposite surface of the porous substrate contacts a lesser amount of the surfactant or mixture of surfactants than the first surface contacts. In certain embodiments, the surfactant or mixture of surfactants is applied as a foam or is otherwise included in a foamed composition. Desirably, the method results in less surfactant adhering to the second surface than the first surface. In general, any type of porous substrate may be treated with a surfactant composition. For example, the porous substrate may be a porous film, an apertured film, a nonwoven web or fabric or even a layer of foam. Generally, the porous substrate is a porous hydrophobic polymer substrate.

As used herein, the term “porous hydrophobic polymer substrate” is meant to include any shaped article, provided it is porous and composed, in whole or in part, of a hydrophobic polymer. For example, the substrate may be a sheet-like material, such as a sheet of a foamed material. The sheet-like material also may be a fibrous web, such as a woven or nonwoven fabric or web. The substrate also may be a hydrophobic polymer fiber, per se, or hydrophobic polymer fibers which have been formed into a fibrous web. The fibrous web desirably will be a nonwoven web, such as, but not limited to, a meltblown web, a spunbonded web, a carded web or an airlaid web. The substrate also may be a laminate of two or more layers of a sheet-like material. For example, the layers may be independently selected from the group consisting of meltblown webs and spunbonded webs. However, other sheet-like materials such as films or foams may be used in addition to, or instead of, meltblown and spunbonded webs. In addition, the layers of the laminate may be prepared from the same hydrophobic polymer or different hydrophobic polymers.

The porous hydrophobic substrate includes hydrophobic nonwovens that may include natural fibers as well as synthetic fibers. According to one desirable embodiment of the present invention, the fibers of the substrate are substantially uniformly coated with a hydrophilic treatment. As an example, a nonwoven fabric made from hydrophobic synthetic fibers, such as polyolefin fibers, is treated with a composition and a method of the present invention to provide a wettable, polyolefin nonwoven fabric. The polyolefin fibers that form the fabric may include polyethylene and/or polypropylene fibers and fibers produced from compositions and blends that include a polyethylene and/or a polypropylene resin and may be produced by various known methods.

The hydrophobic polymer fibers and/or nonwoven substrate generally may be prepared by any known means. As a practical matter, however, the fibers usually will be prepared by a melt-extrusion process and formed into a fibrous web, such as a nonwoven web. The term “melt-extrusion process” as applied to a nonwoven web is meant to include a nonwoven web prepared by any melt-extrusion process for forming a nonwoven web in which melt-extrusion to form fibers is followed by web formation, typically concurrently, on a porous support. The term includes, among others, such well-known processes as meltblowing, coforming, spunbonding, and so forth. By way of illustration only, such processes are exemplified by the following references: meltblowing references include, by way of example, U.S. Pat. No. 3,016,599 to R. W. Perry, Jr., U.S. Pat. No. 3,704,198 to J. S. Prentice, U.S. Pat. No. 3,755,527 to J. P. Keller et al., U.S. Pat. No. 3,849,241 to R. R. Buntin et al., U.S. Pat. No. 3,978,185 to R. R. Buntin et al., and U.S. Pat. No. 4,663,220 to T. J. Wisneski et al. See, also, V. A. Wente, “Superfine Thermoplastic Fibers”, Industrial and Engineering Chemistry, Vol. 48, No. 8, pp. 1342-1346 (1956); V. A. Wente et al., “Manufacture of Superfine Organic Fibers”, Navy Research Laboratory, Washington, D.C., NRL Report 4364 (111437), dated May 25, 1954, United States Department of Commerce, Office of Technical Services; and Robert R. Buntin and Dwight T. Lohkamp, “Melt Blowing—A One-Step Web Process for New Nonwoven Products”, Journal of the Technical Association of the Pulp and Paper Industry, Vol. 56, No.4, pp. 74-77 (1973); coforming references include U.S. Pat. No. 4,100,324 to R. A. Anderson et al. and U.S. Pat. No. 4,118,531 to E. R. Hauser; and spunbonding references include, among others, U.S. Pat. No. 3,341,394 to Kinney, U.S. Pat. No. 3,655,862 to Dorschner et al., U.S. Pat. No. 3,692,618 to Dorschner et al., U.S. Pat. No. 3,705,068 to Dobo et al., U.S. Pat. No. 3,802,817 to Matsuki et al., U.S. Pat. No. 3,853,651 to Porte, U.S. Pat. No. 4,064,605 to Akiyama et al., U.S. Pat. No. 4,091,140 to Harmon, U.S. Pat. No. 4,100,319 to Schwartz, U.S. Pat. No. 4,340,563 to Appel and Morman, U.S. Pat. No. 4,405,297 to Appel and Morman, U.S. Pat. No. 4,434,204 to Hartman et al., U.S. Pat. No. 4,627,811 to Greiser and Wagner, and U.S. Pat. No. 4,644,045 to Fowells.

Other methods for preparing nonwoven webs are, of course, known and may be employed. Such methods include air laying, wet laying, carding, and so forth. In some cases it may be either desirable or necessary to stabilize the nonwoven web by known means, such as thermal point bonding, through-air bonding, and hydroentangling. In addition to nonwoven webs, the hydrophobic polymer fibers may be in the form of continuous filaments or staple fibers, as well as woven or knitted fabrics prepared from such continuous filaments or staple fibers. Furthermore, the nonwoven web may include bicomponent or other multicomponent fibers. Exemplary multicomponent nonwoven webs are described in U.S. Pat. No. 5,382,400 issued to Pike et al., U.S. patent application Ser. No. 10/037,467 entitled “High Loft Low Density Nonwoven Webs Of Crimped Filaments And Methods Of Making Same” and U.S. patent application Ser. No. 10/136,702 entitled “Methods For Making Nonwoven Materials On A Surface Having Surface Features And Nonwoven Materials Having Surface Features” which are hereby incorporated by reference herein in their entirety. Sheath/core bicomponent fibers where the sheath is a polyolefin such as polyethylene or polypropylene and the core is polyester such as poly(ethylene terephthalate) or poly(butylene terephthalate) may also be used to produce carded webs or spunbonded webs. The primary role of the polyester core is to provide resiliency and thus to maintain or recover bulk under/after load. Bulk retention and recovery plays a role in separation of the skin from the absorbent structure. This separation has shown an effect on skin dryness. The combination of skin separation provided with a resilient structure along with a treatment such of the present invention may provide an overall more efficient material for fluid handling and skin dryness purposes.

The term “hydrophobic polymer” is used herein to mean any polymer resistant to wetting, or not readily wet, by water, i.e., having a lack of affinity for water. Examples of hydrophobic polymers include, by way of illustration only, polyolefins, such as polyethylene, poly(isobutene), poly(isoprene), poly(4-methyl-1-pentene), polypropylene, ethylene-propylene copolymers, ethylene-propylene-hexadiene copolymers, and ethylene-vinyl acetate copolymers; styrene polymers, such as poly(styrene), poly(2-methylstyrene), styrene-acrylonitrile copolymers having less than about 20 mole-percent acrylonitrile, and styrene-2,2,3,3,-tetrafluoropropyl methacrylate copolymers; halogenated hydrocarbon polymers, such as poly(chlorotrifluoroethylene), chlorotrifluoroethylene-tetrafluoroethylene copolymers, poly(hexafluoropropylene), poly(tetrafluoroethylene), tetrafluoroethylene-ethylene copolymers, poly(trifluoroethylene), poly(vinyl fluoride), and poly(vinylidene fluoride); vinyl polymers, such as poly(vinyl butyrate), poly(vinyl decanoate), poly(vinyl dodecanoate), poly(vinyl hexadecanoate), poly(vinyl hexanoate), poly(vinyl propionate), poly(vinyl octanoate), poly(heptafluoroisopropoxyethylene), poly(heptafluoroisopropoxypropylene), and poly(methacrylonitrile); acrylic polymers, such as poly(n-butyl acetate), poly(ethyl acrylate), poly[(1-chlorodifluoromethyl)tetrafluoroethyl acrylate], poly[di(chlorofluoromethyl)fluoromethyl acrylate], poly(1,1-dihydroheptafluorobutyl acrylate), poly(1,1-dihydropentafluoroisopropyl acrylate), poly(1,1-dihydropentadecafluorooctyl acrylate), poly(heptafluoroisopropyl acrylate), poly[5-(heptafluoroisopropoxy)pentyl acrylate], poly[11-(heptafluoroisopropoxy)undecyl acrylate], poly[2-(heptafluoropropoxy)ethyl acrylate], and poly(nonafluoroisobutyl acrylate); methacrylic polymers, such as poly(benzyl methacrylate), poly(n-butyl methacrylate), poly(isobutyl methacrylate), poly(t-butyl methacrylate), poly(t-butylaminoethyl methacrylate), poly(dodecyl methacrylate), poly(ethyl methacrylate), poly(2-ethylhexyl methacrylate), poly(n-hexyl methacrylate), poly(phenyl methacrylate), poly(n-propyl methacrylate), poly(octadecyl methacrylate), poly(1,1-dihydropentadecafluorooctyl methacrylate), poly(heptafluoroisopropyl methacrylate), poly(heptadecafluorooctyl methacrylate), poly(1-hydrotetrafluoroethyl methacrylate), poly(1,1-dihydrotetrafluoropropyl methacrylate), poly(1-hydrohexafluoroisopropyl methacrylate), and poly)t-nonafluorobutyl methacrylate); and polyesters, such a poly(ethylene terephthalate) and poly(butylene terephthalate).

The term “polyolefin” is used herein to mean a polymer prepared by the addition polymerization of one or more unsaturated monomers which contain only carbon and hydrogen atoms. Examples of such polyolefins include polyethylene, polypropylene, poly(1-butene), poly(2-butene), poly(1-pentene), poly(2-pentene), poly(3-methyl-1-pentene), poly(4-methyl-1-pentene), and so forth. In addition, such term is meant to include blends of two or more polyolefins and random and block copolymers prepared from two or more different unsaturated monomers. Because of their commercial importance, the most desired polyolefins are polyethylene and polypropylene. The polyolefin may contain additives as is known or customary in the art. For example, the polyolefin may contain pigments, opacifiers, fillers, delustrants, antioxidants, antistatic agents, stabilizers, oxygen scavengers, and so forth.

In at least one desirable embodiment, at least one surface of the substrate, is imparted with a durable hydrophilic treatment so that the substrate may be used in absorbent, personal care products and other disposable, absorbent products. The term “durable” as used herein with reference to a coating of a hydrophilic polymeric material on a fiber or other substrate means that the coated porous substrate remains wettable after multiple exposures to an aqueous medium, such as water, saline, urine, and other body fluids. One procedure for evaluating durability when the porous substrate is a fibrous web is a modified run-off test followed by washing and drying (a wash/dry cycle). The fibrous web typically may remain wettable for at least three and even five cycles of exposing, washing, and drying. In another desirable embodiment, the surface of the substrate that is oriented toward the exterior, i.e. the skin contacting surface, includes no or essentially no surfactant, for example less than 0.05 weight percent surfactant relative to the weight of the substrate.

The treatment composition of the present invention may include any number of components one of which is a surfactant. One suggested surfactant is an alkyl polyglycoside or a derivative of an alkyl polyglycoside. Suggested alkyl polyglycosides include, but are not limited to, alkyl polyglycosides having 8 to 10 carbons in the alkyl chain. A particular suggested alkyl polyglycoside is an alkyl polyglycoside having 8 carbon atoms in the alkyl chain, an octylpolyglycoside. A commercial example of such an octylpolyglycoside includes, but is not limited to, GLUCOPON 220 UP which is provided in an aqueous solution of 60 weight percent of an alkylpolyglycoside having the following chemical formula 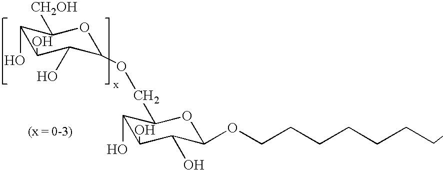
where x is selected from the group of integers 0, 1, 2 and 3. GLUCOPON 220 UP (also referred to simply as “GLUCOPON”) is commercially available from Cognis Corporation of Ambler, Pa.

Another suggested surfacantat is a mixture of a hydrogenated, ethoxylated castor oil and sorbitan monooleate. A suggested example of a commercially available example of a mixture of a hydrogenated, ethoxylated castor oil and sorbitan monooleate includes, but is not limited to, a surfactant mixture sold under the tradename AHCOVEL Base N-62. AHCOVEL Base N-62 (also referred to simply as “AHCOVEL”) is a blend of a hydrogenated, ethoxylated castor oil and sorbitan monooleate that is provided in about a mixture of about a 1:1 ratio (more specifically 55 percent sorbitan monooleate and 45 percent hydrogenated, ethoxylated castor oil). AHCOVEL Base N-62 can be obtained 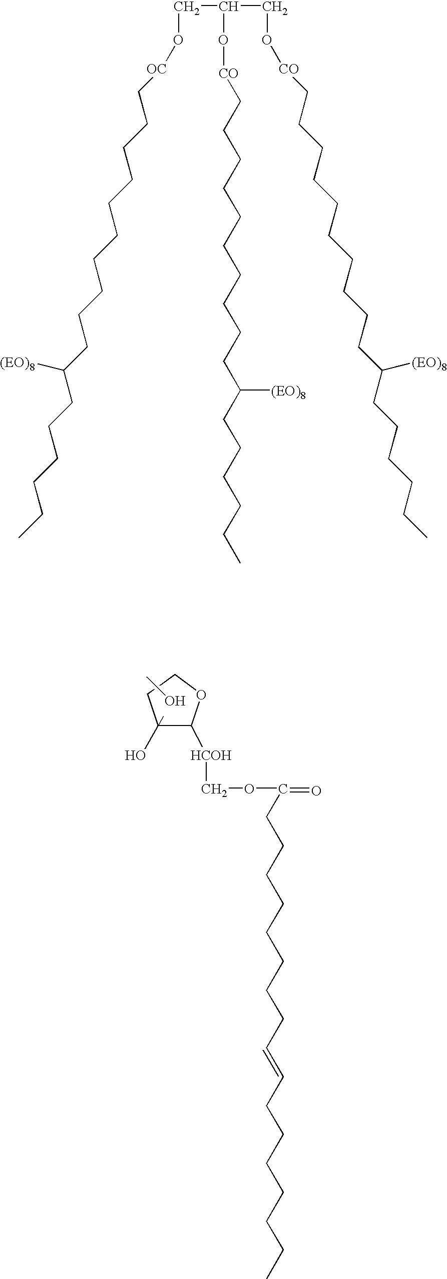
from Uniqema a division of ICI having offices in New Castle, Del.

As previously stated, the treatment composition may include additional components for example a siloxane polyether, or more specifically an ethoxylated polyalkyl siloxane. Suggested examples of ethoxylated polyalkyl siloxane, include, but are not limited to, polyethylene glycol-grafted trisiloxane of the following chemical formula: 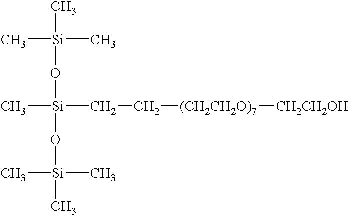
A suggested commercially available example of an ethoxylated polyalkyl siloxane suitable for treatment compositions of the present invention includes but, is not limited to, MASIL SF-19 siloxane polyether available from BASF of Gurnee Ill. MASIL SF-19 is an ethoxylated trisiloxane of the above chemical formula.

The components of the treatment composition, for example a 3 to 1 mixture of AHCOVEL Base N-62 surfactant and GLUCOPON 220 UP surfactant, can be combined with water and applied as a foamed formulation. Again, treatment compositions of the present invention may further include additional optional components. It is suggested that the aqueous treatment composition may include at least about 15 weight percent of a surfactant or a combination of surfactants. In an exemplary embodiment, the aqueous treatment composition includes 18 weight percent of a mixture of about 3 parts AHCOVEL Base N-62 surfactant to about 1 part GLUCOPON 220 UP surfactant in water. In another embodiment, the aqueous treatment composition may include optional skin health ingredients such as aloe vera, vitamins E, vitamin E acetate, vitamin D, d-penthenol, botanical extracts and so forth. In yet another embodiment, the aqueous treatment composition may include optional anti-oxidants, fragrance, and preservatives.

The present invention further provides a foamed aqueous treatment composition for a substrate, the aqueous treatment composition that includes: from about 70 weight percent to about 95 weight percent of water; from about 1.5 weight percent to about 15 weight percent of sorbitan monooleate; from about 1 weight percent to about 10 weight percent of an ethoxylated, hydrogenated castor oil; from about 0.5 weight percent to about 5 weight percent of an alkyl polyglycoside or a derivative of an alkyl polyglycoside. The aqueous treatment composition may include from about 80 weight percent to about 95 weight percent of water. It is suggested that the aqueous treatment composition includes at least about 3 weight percent of sorbitan monooleate, at least about 2 weight percent of the ethoxylated, hydrogenated castor oil, and at least about 1 weight percent of the alkyl polyglycoside. It is further suggested that the aqueous treatment composition includes from about 80 weight percent to about 95 weight percent of water; from about 2 weight percent to about 10 weight percent of sorbitan monooleate; from about 1.5 weight percent to about 10 weight percent of an ethoxylated, hydrogenated castor oil; and from about 0.75 weight percent to about 5 weight percent of an alkyl polyglycoside or a derivative of an alkyl polyglycoside.

The treatment solution is applied over one of surfaces of the substrate or may vary and may be varied in a controlled manner across at least one dimension or zone of a porous substrate. For example, a coated porous substrate may have a central region of higher hydrophilicity which extends, for example, along the length of the substrate, with regions of lower hydrophilicity on both sides of the central region. Thus, the hydrophilicity of such a substrate would vary in a controlled manner across the width thereof. Other variations coming within the scope of the present invention will be readily apparent to those having ordinary skill in the art.

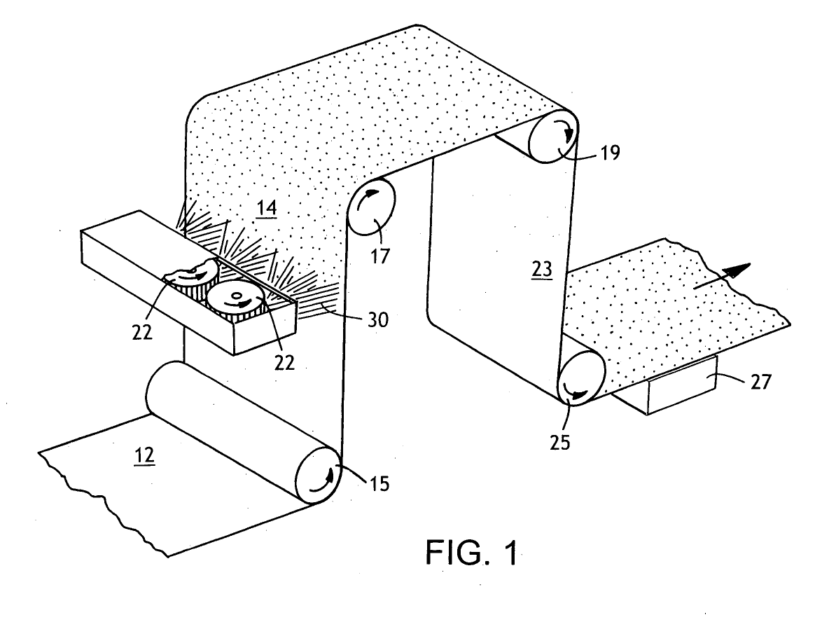

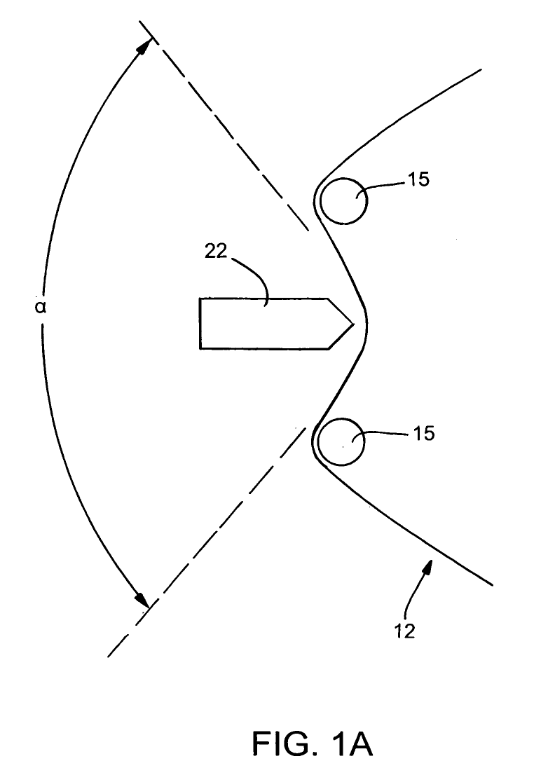

Turning now to the method for preparing a treated porous substrate, the method involves providing a porous hydrophobic polymer substrate and exposing at least a portion of the substrate to a foamed composition that includes at least one surfactant. A suggested combination of surfactants includes contacting the porous substrate with a mixture that includes an octylpolyglycoside sorbitan monooleate, at least about 2 weight percent of the ethoxylated, hydrogenated castor oil. The surfactant(s) and any other optional components of the treatment composition may be applied separately or combined and may be included in water mixture and are desirably applied as an aqueous foamed treatment. The treatment composition(s) may further include other components, such as co-surfactants, anti-foam agents, if needed or desirable, emulsifiers, lubricants, anti-stats, skin care ingredients, anti-oxidants, vitamins, botanical extracts, scents, odor control agents, color, and anti-microbials. Exemplary methods of treating a substrate with treatment compositions are provided in the figures where FIG. 1 illustrates a first exemplary process that sprays a treatment composition on a substrate.

Referring to FIG. 1, an exemplary process for applying a treatment composition of the present invention to one side of a traveling web will be described. It should be appreciated by those skilled in the art that the invention is equally applicable to inline treatment or a separate, offline treatment step. Web 12, for example a spunbond or meltblown nonwoven, is directed under support roll 15 to a treating station including rotary spray heads 22 for application to one side 14 of web 12. The treatment station receives a supply of treating liquid 30 from a reservoir (not shown).

The treatment station may include a rotary spray system that applies the treatment composition. This particular spray process requires the addition of an antifoam agent such as Dow Corning 2210 (Dow Corning, Inc., Midland, Mich.) at about 0.15 weight percent. An exemplary rotary spray system is illustrated in FIGS. 1, 3 and 4 illustrates an exemplary rotary spray zoned treatment application apparatus and system. A suggested system and apparatus that includes the components illustrated in the figures includes a “WEKO” system. The WEKO apparatus and system can be obtained from WEKO, Biel AG, Switzerland. The configuration includes a centrifugal damping application system using a single or double rotocarrier. The surfactant formulation is pumped to the header through a gear pump where it is fed to the damping rotors through restrictor tubes. The system is equipped with a series of rotors 50, which may spin at a speed of about 4500 rpm. Under the effect of a centrifugal force generated by the spinning rotors 50, a treatment composition may be dispensed to the nonwoven fabric or other substrate 52 in the form of an aerosol or small droplets 54. Throughput as measured in gram/minute is controlled and adjusted with different diameter restrictor tubes, header pressure and bath parameters (e.g. concentration and temperature). Additionally, finer throughput control may be achieved by adding optional needle valves to the outlet ports of the header. If a zone treatment is desired, templates 60 made of stainless steel or another solid material of a predetermined width are placed in front of the web so that the spray is applied to the material only through the template opening(s) 62. A suggested template opening is 4 inches and provides a 4-inch wide treated zone 53 to a nonwoven material 52.

The treated web may then be dried if needed by passing over dryer cans (not shown) or other drying means and then under support roll 25 to be wound as a roll or converted to the use for which it is intended. For a polypropylene web, drying can be achieved by heating the treated web to a temperature from about 220° F. to 300° F., more desirably to a temperature from 250° F. to 290° F., by passage over a heated drum to set the treatment composition and complete drying. In one desirable embodiment, the treated web is dried by passing the web through a gas stream, desirably a heated air stream, so that the gas stream is directed generally from the lesser treated surface toward the greater treated surface to dry the treated web and drive the treatment composition away from the lesser treated surface toward the greater treated surface. FIG. 1 illustrates a blower 27 that may be used to direct heated air at untreated surface toward the treated surface and dry the treated web. Directional air flow may be used to further increase the relative amount of surface treatment between the two opposing surfaces of the treated web. Drying temperatures for other polymers will be apparent to those skilled in the art. Alternative drying means include ovens, through air dryers, infrared dryers, air blowers, and so forth.

A suggested process that may be used to apply treatment compositions of the present invention to a substrate includes a foaming process. Foaming is a desirable process because of its chemical use efficiency, ease of operation, cleanliness, and good control over process parameters. Advantageously, a foaming process may be modified to allow one side of a substrate to be treated at a higher concentration than the other side of the substrate. Desirably, one side is treated predominantly and, more desirably, the other side of the substrate is virtually untreated. Suggested methods of treating one side of a substrate at a higher rate than the other side include: (1) applying a treatment solution to a moving substrate at a point where the substrate glides over a foam applicator, where the fabric touches the foam applicator at a high wrap angle, for example 150 degrees, to minimize foam compression at the point of application; (2) applying a treatment solution or suspension using a foamed treatment solution or suspension having a high concentration of solids, for example 20 weight percent or higher; (3) applying a treatment solution or suspension using a foamed treatment solution or suspension having a high viscosity to minimize foam penetration through the substrate to the other lesser treated side; or (4) applying a heated gas stream toward the substrate in a direction that is generally from the untreated or lesser treated side toward the treated or more treated side to minimize saturation of the substrate by the treatment composition. One or more of these methods may be combined to provide a sided, treated material.

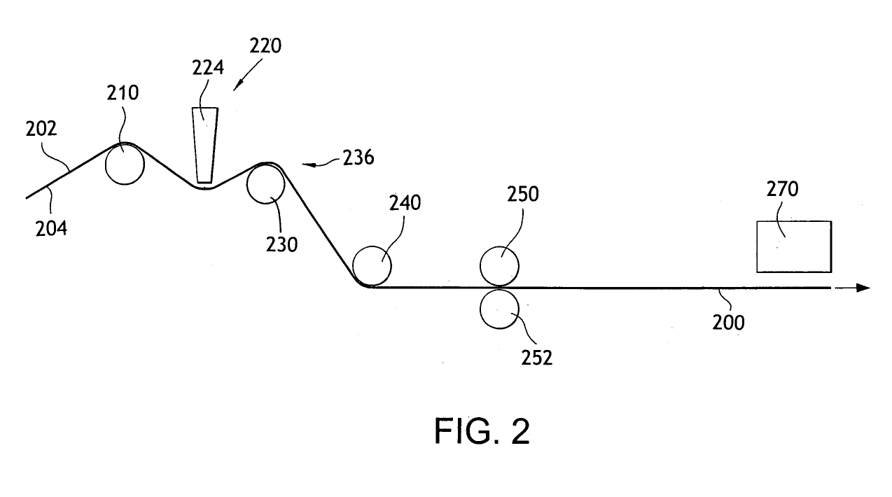

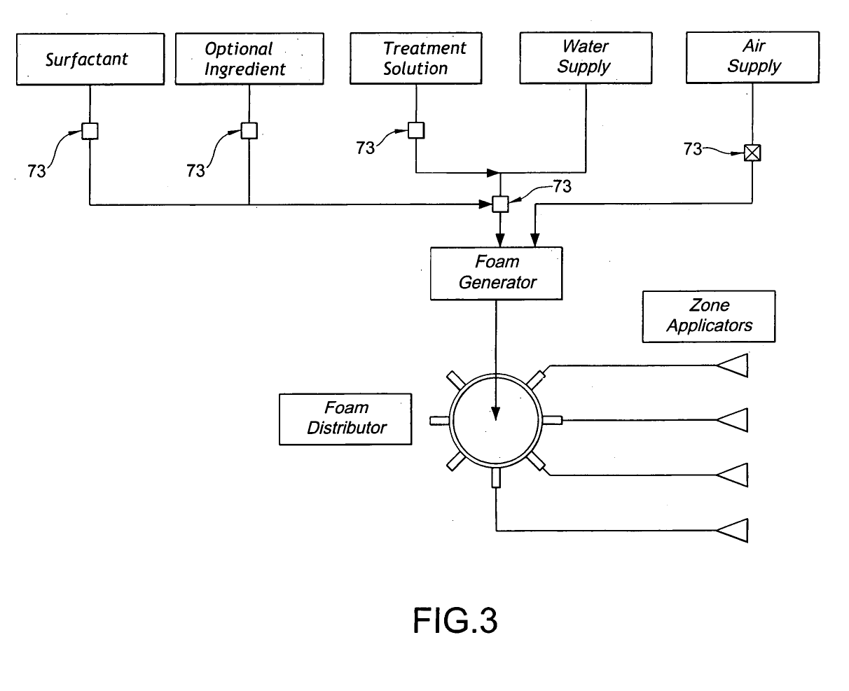

A general schematic diagram of a foam process is shown in FIG. 3 and includes chemical tanks, air and water supplies, and metering devices (e.g. pumps, valves and flow meters) connected to a high shear-mixing chamber. Suggested foam equipment can be obtained from Gaston Systems, Incorporated of Stanley, N.C. This equipment includes a parabolic foam applicator with a 1/8 inch slot opening and a slot width that is adjustable from about 11 inches to about 18 inches, but may be as wide as 120 inches or more. This kind of foam equipment is capable of full width treatment or zone treatment. The zone treatment is achieved by using foam applicator of a specific width, e.g. 4 inches wide. In the case of zone treatment multiple 4 inch wide foam applicators may be used to simultaneously treat multiple slits of a nonwoven base roll as illustrated in FIG. 4. Desirable options for a foam treater include, vacuum suction below and/or above the foam applicators. A combination of process settings may be selected based on foam application, e.g. single or dual side, and vacuum may be selected for optimum treatment uniformity and minimum impact on web structure. Various other methods may be employed for contacting a substrate with the treatment composition or compositions in accordance with the invention. For example, a substrate may be treated by means of print rolls, slot die coating, saturation, or other conventional coating techniques.

In a desirable embodiment, a nonwoven web is treated with compositions and methods of the present invention to improve wettability, absorbency and the fluid intake ability of the web. The treated nonwoven web may be incorporated into a personal care product, such as an absorbent core wrap or transfer layer material in a diaper or other personal care product, to provide improved skin dryness. Furthermore, the components of the treatment composition may be applied in separate steps or in one combined step. It should also be understood that the method and hydrophilic surface treatment of nonwoven materials with topical application of surfactants of this invention may incorporate not only multiple surfactants for improved wettability with aqueous fluids (e.g. urine), or to facilitate management of other body fluids (blood, menstrual fluid, feces, etc.), but may also be used to incorporate bioactive compounds and other macromolecules, which may afford biofunctional attributes to the surface treatments of this invention (e.g. antibacterial activity, preservativation, anti-inflammatory, odor control, skin wellness and so forth). For example, a nonwoven web or fibers of the present invention may include optional skin care, odor control and/or antibacterial ingredients. Desirably, a treatment or coating of the present invention is durable to multiple exposures to an aqueous medium at a temperature in a range of from about 10° C. to about 50° C. Treated nonwoven webs of the present invention may vary in basis weight and/or density and may be applicable to a variety of applications including, but not limited to, components of various personal care and absorbent products, wipers, such as infant wipers and clean room wipers, and so forth. One suggested use of a sided, treated substrate of the present invention is as a bodyside liner or topsheet of an absorbent article, such as a diaper, or other personal care product. As used herein, the term “personal care product” means bandages and wound care items, diapers, training pants, swimwear, absorbent underpants, adult incontinence products, feminine hygiene products mortuary absorbent products, veterinary absorbent products and so forth.

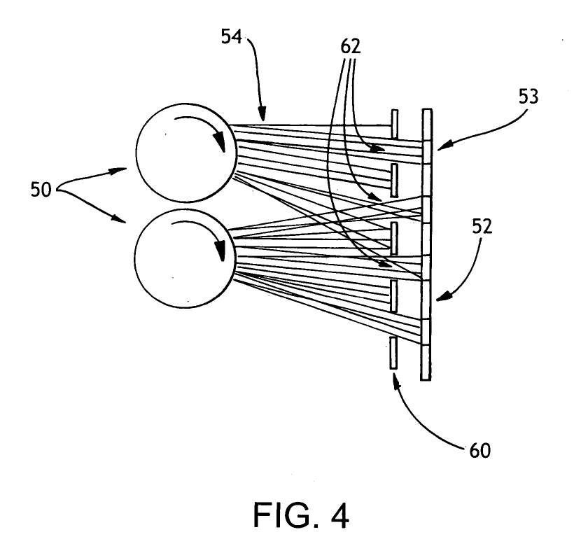

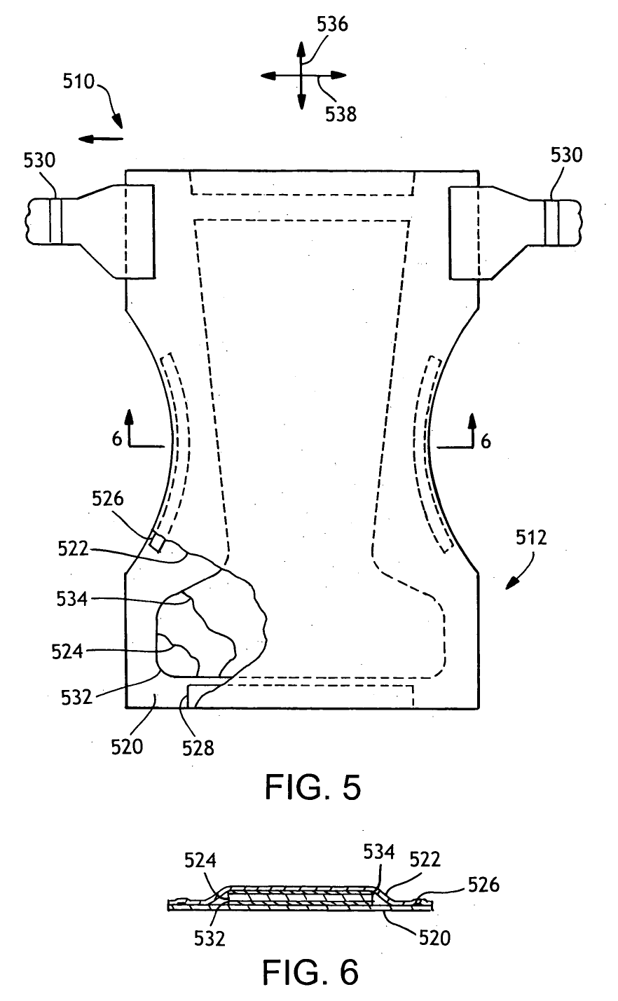

An exemplary absorbent article is illustrated in FIGS. 5 and 6 and includes a vapor permeable backsheet 520, a liquid permeable topsheet 522 positioned in facing relation with the backsheet 520, and an absorbent body or material 524, such as an absorbent pad or the like, which is located between the backsheet 520 and the topsheet 522. The backsheet 520 defines a length and a width which, in the illustrated embodiment, coincide with the length and width of the diaper 10. The absorbent body 524 generally defines a length and width which are less than the length and width of the backsheet 520, respectively. Thus, marginal portions of the diaper 510, such as marginal sections of the backsheet 520, may extend past the terminal edges of the absorbent body 524. In the illustrated embodiments, for example, the backsheet 520 extends outwardly beyond the terminal marginal edges of the absorbent body 524 to form side margins and end margins of the diaper 510. The topsheet 522 is generally coextensive with the backsheet 520 but may optionally cover an area which is larger or smaller than the area of the backsheet 520, as desired. The backsheet 520 and topsheet 522 are intended to face the garment and body of the wearer, respectively, while in use.

Examples of other diaper configurations suitable for use in connection with the treated substrates of the application which may include other diaper components suitable for use on diapers are described in U.S. Pat. No. 4,798,603 issued Jan. 17, 1989, to Meyer et al.; U.S. Pat. No. 5,176,668 issued Jan. 5, 1993, to Bernardin; U.S. Pat. No. 5,176,672 issued Jan. 5, 1993, to Bruemmer et al.; U.S. Pat. No. 5,192,606 issued Mar. 9, 1993, to Proxmire et al., and U.S. Pat. No. 5,509,915 issued Apr. 23, 1996 to Hanson et al., the disclosures of which are herein incorporated by reference in their entirety.

Various woven and nonwoven fabrics may be used to construct the surge management layer 534. For example, the surge management layer 534 may be a layer composed of a meltblown or spunbonded web of synthetic fibers, such as polyolefin fibers. The surge management layer 534 may also, for example, be a bonded-carded-web or an airlaid web composed of natural and synthetic fibers. The bonded-carded-web may, for example, be a thermally bonded web which is bonded using low melt binder fibers, powder or adhesive. The webs may optionally include a mixture of different fibers. Although the layer of surge material may itself be made up of one or more layers of materials, for purposes of this disclosure the surge layer shall be referred to, for descriptive purposes only, as one layer. The surge management layer 534 may be composed of a substantially hydrophobic material, and the hydrophobic material may optionally be treated with a surfactant or otherwise processed to impart a desired level of wettability and hydrophilicity. In a particular embodiment, the surge management layer 534 includes a hydrophilic, nonwoven material having a basis weight of from about 30 to about 120 grams per square meter (gsm).

For example, in a particular embodiment, the surge management layer 534 may comprise a bonded-carded-web, nonwoven fabric which includes bicomponent fibers and which defines an overall basis weight of about 83 grams per square meter. The surge management layer 534 in such a configuration may be a homogeneous blend composed of about 60 weight percent polyethylene/polyester (PE/PET), sheath-core bicomponent fibers which have a fiber denier of about 2 and about 40 weight percent single component polyester fibers which have a fiber denier of about 3 and which have nominal fiber lengths of from about 3.8 to about 5.08 centimeters. In a particular embodiment, the treatment composition is applied to the surge management layer.

In the illustrated embodiments, the surge management layer 534 is preferably arranged in a direct, contacting liquid communication fashion with the absorbent body 524. The surge management layer 534 may be operably connected to the topsheet 522 with a conventional pattern of adhesive, such as a swirl adhesive pattern. In addition, the surge management layer 534 may be operably connected to the absorbent body 524 with a conventional pattern of adhesive. The amount of adhesive add-on should be sufficient to provide the desired levels of bonding, but should be low enough to avoid excessively restricting the movement of liquid from the topsheet 522, through the surge management layer 534 and into the absorbent body 524.

The absorbent body 524 is desirably positioned in liquid communication with surge management layer 534 to receive liquids released from the surge management layer, and to hold and store the liquid. In the shown embodiments, the surge management layer 534 comprises a separate layer which is positioned, at least in part, over another separate layer comprising the absorbent body 524, thereby forming a dual-layer arrangement. The surge management layer 534 serves to quickly collect and temporarily hold discharged liquids, to transport such liquids from the point of initial contact and spread the liquid to other parts of the surge management layer 534, and then to substantially completely release such liquids into the layer or layers comprising the absorbent body 524.

The surge management layer 534 may be of any desired shape. Suitable shapes include for example, circular, rectangular, triangular, trapezoidal, oblong, dog-boned, hourglass-shaped, or oval. In certain embodiments, for example, the surge management layer may be generally rectangular-shaped. In the illustrated embodiments, the surge management layer 534 is coextensive with the absorbent body 524. Alternatively, the surge management layer 534 may extend over only a part of the absorbent body 524. Where the surge management layer 534 extends only partially along the length of the absorbent body 524, the surge management layer 534 may be selectively positioned anywhere along the absorbent body 524. For example, the surge management layer 534 may function more efficiently when it is offset toward the front waist section 512 of the garment. The surge management layer 534 may also be approximately centered about the longitudinal center line of the absorbent body 524.

Additional materials suitable for the surge management layer 534 are set forth in U.S. Pat. No. 5,486,166 issued Jan. 23, 1996 in the name of Ellis et al. and entitled “Fibrous Nonwoven Web Surge Layer For Personal Care Absorbent Articles And The Like”; U.S. Pat. No. 5,490,846 issued Feb. 13, 1996 in the name of Ellis et al. and entitled “Improved Surge Management Fibrous Nonwoven Web For Personal Care Absorbent Articles And The Like”; and U.S. Pat. No. 5,364,382 issued Nov. 15, 1994 in the name of Latimer et al. and entitled “Absorbent Structure Having Improved Fluid Surge Management And Product Incorporating Same”, the disclosures of which are hereby incorporated by reference in their entirety.

The present invention also contemplates a disposable absorbent article including a vapor permeable backsheet having a WVTR (test method as described in U.S. Pat. No. 6,296,862) of at least about 1000 grams/m²/24 hr; a liquid permeable topsheet in facing relation with the backsheet; an absorbent body located between the backsheet and the topsheet, the absorbent body located in one or more regions of the article. Further still, it is desirable for the vapor permeable backsheet to be substantially liquid impermeable. The absorbent article may also be a personal care product, such as a diaper, training pant, absorbent underpant, adult incontinence product, feminine hygiene product, hygiene and absorbent product or the like.

The present invention provides absorbent articles that include an improved topsheet or liner that includes more surfactant on one surface than the other surface and methods of making such topsheets, liners and other substrates. Desirably, the surface of the substrate that includes the greater amount of surfactant is oriented away from the skin of a wearer of a product that includes the substrate. In certain embodiments, the step of contacting a surfactant or a mixture of surfactants to the first surface of the substrate includes contacting a foam that comprises the surfactant or mixture of surfactants to the first surface. As used herein, the term “foam” generally refers to a porous matrix, which is an aggregate of hollow cells or bubbles, the walls of which contain liquid material. The cells may be interconnected to form channels or capillaries within the foam structure wherein such channels or capillaries facilitate liquid distribution within the foam. A variety of compositions may be formed into a foam and applied to a porous substrate in accordance with the present invention. For instance, in one embodiment, a “liquid-based” composition may be foamed onto the nonwoven material. As used herein, a “liquid-based” composition generally refers to any composition that is capable of existing in a liquid state. In particular, a “liquid-based” composition may exist naturally in a liquid state, or may require liquid-enhancing aids, such as heating, foaming aids (e.g., surfactants), etc., to achieve such a liquid state. Moreover, a “liquid-based” composition also includes emulsions having a certain solids content.

Desirably, the ratio of the air volume to the liquid volume of the foam is less than about 50:1 and the foam includes an aqueous solution, dispersion or emulsion that comprises greater than about 2 weight percent of the surfactant or mixture of surfactants, preferably between about 5 and about 30 weight percent, more desirably between about 10 and about 25 weight percent. In certain embodiments, the surfactant or a mixture of surfactants is contacted to the porous substrate at an add-on level of less than about 0.5 weight percent of the surfactant or mixture of surfactants relative to the weight of the porous substrate. In certain embodiments, the aqueous solution, dispersion or emulsion of the surfactant or mixture of surfactants has a viscosity of greater than about 10 cps. In certain embodiments, the method further includes bending the porous substrate in a second direction around an apparatus to define a wrap angle of from about 90° to 180° and contacting the surfactant or mixture of surfactants to the first surface of the porous substrate at about the point the porous substrate bends around the apparatus. The wrap angle α is illustrated in FIG. 1A and is defined as the portion of the circumference of the web at the point the web is treated and is expressed in degrees. Desirably, the wrap angle ranges from about 120° to 180° and, even more desirably, the wrap angle ranges from about 150° to 170°. In certain embodiments, the method further includes drying the porous, treated substrate by directing a gas, particularly heated air, at the substrate in a direction that is generally from the second surface toward the first surface.

Desirably, the foam composition has a “blow ratio”, i.e. a ratio of air volume to liquid volume, that is about 50 to 1 in order to minimize foam driving pressure from the first surface toward the second surface of the substrate, thus minimizing saturation of the substrate and contact of the foam to the second surface. The blow ratio may be maintained at a desired value by controlling the flow rates of the liquid and air streams. Specifically, in most embodiments, the foam composition of the present invention has a blow ratio of about 50:1, and particularly between about 40:1 to about 30:1. For example, in one embodiment, the blow ratio may be between about 50:1 to about 30:1, while in another embodiment, the blow ratio may be between about 40:1 to about 20:1. In addition to the blow ratio, control over the component flow rates may also allow the foam to be generally stable before being applied to the substrate. In particular, the foam composition of the present invention should desirably have a half-life greater than about 3 minutes, particularly between about 3 minutes to about 30 minutes, and more particularly between about 10 minutes to about 20 minutes.

Once the foam composition is formed, the composition may then generally be extruded or otherwise contacted onto a moving substrate utilizing any of a variety of foam applicators. For example, in one embodiment, a foam applicator having a distribution chamber and an extrusion head may be utilized. In general, the distribution chamber may have any shape or size. In one embodiment, for example, the distribution chamber has a parabolic shape. Moreover, the extrusion head may also generally have any shape or size. For example, in one embodiment, the extrusion head has a straight-slot shape.

The present invention is further illustrated by the following examples which are representative of the invention although other examples will be apparent to those skilled in the art and are intended to be covered by the claims.

### TREATING FORMULATION FOR THE EXAMPLES

A foamable surface treatment solution was prepared. The treatment solution consisted of about 18 weight percent aqueous solution of a 3:1 blend of AHCOVEL Base N-62 surfactant obtained from Uniqema a division of ICI having offices in New Castle, Del. and GLUCOPON 220 UP surfactant available from Cognis Corporation of Ambler, Pa. The solution was subjected to high shear mixing using a GASTON Systems equipment CFS from Gaston Systems, Inc. of Stanley, N.C. with a built-in mixer set at 600 rpm for about 30 minutes to generate a uniform and small cell size foam from the components of the solution. The foam was then immediately smeared via a parabolic applicator having ⅛″ slot opening onto one side of a sample of spunbond liner material. The add-on level of the treatment composition may be controlled by varying bath concentration, flow rate of the treatment composition through the applicator onto the material to be treated and/or line speed of the material to be treated among other variables.

The liner was subsequently dried in a hot air dryer by directing heated air at both surfaces of the liner but by directing more air toward the surface of the liner that was not treated so that the flow of heated air was greater on the untreated side of the liner, thus, minimizing soak through of the treatment composition to the untreated side of the liner. The spunbond liner material of the Examples was a 0.5 osy, made from Exxon PP 3155 polypropylene resin made that can be obtained from Kimberly-Clark Corporation.

### Control Example A

Control Example A was a untreated sample of spunbond liner material. The spunbond liner material consisted of a web of about 2.7 denier polypropylene spunbonded fibers having basis weight of about 0.5 osy. A surface of the untreated spunbond liner material was examined using X-ray photoelectron spectroscopy (XPS) to assess the atomic composition of the surface of the untreated spunbond liner material. XPS analysis revealed that the surface of the untreated spunbond liner material contained 98.05 weight percent of carbon and only 1.96 weight percent of oxygen. The small amount of oxygen present on the surface of an untreated polypropylene nonwoven web is very common and is generally ascribed to oxidation during the polymer melt extrusion and fiber spinning process, as well as migration of processing aids such as anti-oxidant to the surface of polypropylene.

### Example 1

Example 1 was a sample of 0.5 osy spunbond polypropylene liner material treated on one side with the surfactant solution prepared as described above at an add-on level of about 0.25 weight percent. A spunbond liner was surface treated at an add-on level of about 0.25 weight percent of a 3:1 AHCOVEL Base N-62 and GLUCOPON 220 UP surfactant solution using a foam process.

Both sides of the dried, surface treated material of Example 1 were examined using XPS as determined for Control Example A. XPS analysis revealed that the treated side of 0.25 weight percent treated spunbond liner material contained 95.94 weight percent of carbon and 4.61 weight percent of oxygen and the untreated side of the spunbond liner material contained 95.32 weight percent of carbon, 4.06 weight percent of oxygen and 0.16 weight percent of nitrogen. XPS analysis results indicated about 14 percent more oxygen content on the surface of the treated side than on the surface of the untreated side for Example 1. The higher oxygen content confirms that more surfactant is present on the “treated” side than on the “untreated” side of the polypropylene nonwoven material.

A sample of the treated spunbond liner material of Example 1 was substituted for the liner material of a HUGGIES Ultratrim Size 4 diaper by removing the liner from the HUGGIES Ultratrim Size 4 diaper and placing the sample of treated liner with the treated side away the absorbent core and toward the skin of a wearer. TEWL tests were conducted as described above and TEWL was measured at 29.94 g/m²/hr. A second sample of the treated spunbond liner material of Example 1 was substituted for the liner material of a HUGGIES Ultratrim Size 4 diaper by removing the liner from the diaper and placing the sample of treated liner with the treated side toward the absorbent and away from the skin of a wearer. TEWL tests were conducted as described above and TEWL was measured at 28.15 g/m²/hr.

### Example 2

Example 2 was a sample of spunbond liner material treated on one side at an add-on level of about 0.35 weight percent.

Both sides of the dried, surface treated material of Example 2 were examined using XPS as determined for Control Example A and Example 1. X—XPS analysis revealed that the treated side of 0.35 weight percent treated spunbond liner material contained 92.76 weight percent of carbon, 7.22 weight percent of oxygen and 0.02 weight percent of nitrogen and that the untreated side of the spunbond liner material contained 95.49 weight percent of carbon and 4.51 weight percent of oxygen. XPS analysis results indicated about 60 percent more oxygen content on the surface of the treated side than on the surface of the untreated side for Example 2. The higher oxygen content confirms that more surfactant is present on the “treated” side than on the “untreated” side of the polypropylene nonwoven material.

A sample of the treated spunbond liner material of Example 2 was substituted for the liner material of a HUGGIES Ultratrim Size 4 diaper by removing the liner from the HUGGIES Ultratrim Size 4 diaper and placing the sample of treated liner with the treated side away from the absorbent core and toward the skin of a wearer. TEWL tests were conducted as described above and TEWL was measured at 29.61 g/m²/hr. A second sample the of treated spunbond liner material of Example 2 was substituted for the liner material of a HUGGIES Ultratrim Size 4 diaper by removing the liner from the diaper and placing the sample of treated liner with the treated side toward the absorbent and away from the skin of a wearer. TEWL tests were conducted as described above and TEWL was measured at 29.17 g/m²/hr.

### Example 3

Example 3 was a combination of a one-sided treated liner as described above and a bonded carded surge material treated with a polysaccharide. Results of Table 1, show that the combination of a one-side treated liner and an EHEC treated carded web surge material yields improved TEWL reduction that is greater than the TEWL reduction that is expected if either material is used separately and combined.

TABLE 1

| Topsheet Layer | Surge Management Layer | |
|---|---|---|
| Treatment | Treatment | TEWL |
| Control | Control (L-1 surfactant finish) | 40.8 g/m²/hr |
| (i.e. both sides) | | |
| One-sided | Control (L-1 surfactant finish) | 34.9 g/m²/hr |
| One-sided | EHEC | 31.9 g/m²/hr |

Results indicate the one-sided top sheet treatment to reduce skin hydration as measured by TEWL by 5.9 g/m²/hr. The experimental surge management layer, which has been treated with EHEC, reduced TEWL by an additional 3.0 g/m²/hr for an additive total of 8.9 g/m²/hr. Both the one-side treated top sheet and the EHEC surge management material, unexpectedly, performed synergistically and provided a higher skin dryness benefit than either material used alone and combined.

The bonded carded surge material treated with the polysaccharide was made as follows. A single-layer, bonded carded web having a basis weight of 2.5 ounces per square yard (osy) was formed from a uniform blend of two different fibers. The first fibers were 1.5 denier bicomponent staple fibers that were pretreated with a 0.10 percent by weight solution of ethyl hydroxyethyl cellulose (EHEC) prior to blending with the second fibers resulting in an add-on level of about 0.1 weight percent of EHEC on the finished bicomponent fibers. The second fibers were 6 denier poly(ethylene terephthalate) staple fibers obtained from KoSa of Salisbury, N.C. that were pretreated with a 0.55 weight percent solution of a blend of ethoxylated, hydrogenated castor oil and sorbitan monooleate (referred to as L-1 finish) resulting in an add-on level of about 0.55 weight percent of ethoxylated, hydrogenated castor oil and sorbitan monooleate on the finished poly(ethylene terephthalate) fibers. The bicomponent staple fibers consisted of 45 weight percent of a polyethylene sheath and 55 weight percent of a polypropylene core fibers obtained from KoSa. The bicomponent fibers were pretreated with a 0.10 weight percent aqueous solution of BERMOCOLL EBS E481 FQ (referred to as EHEC in Table 1 below) prior to being combined with polyester fibers treated with a blend of ethoxylated, hydrogenated castor oil and sorbitan monooleate along with processing aids such lubricant and anti-static agents.

The first fibers and the second fibers were combined at a ratio of 60 weight percent of the first, treated fibers and 40 weight percent of the second, untreated fibers and mixed to produce a uniform blend of the fibers. This blend of fibers was carded and bonded, as described in the background section, to produce a bonded carded web having a basis weight of 3.0 osy. This bonded carded web was then inserted between the body-side liner and the absorbent core of a HUGGIES Ultratrim Size 4 diaper to replace the previous surge layer. The materials were then tested on human subjects for TransEpidermal Water Loss using the test procedure details above and using three different outercovers having different breathabilities as measure in units of MOCON. The first and least breathable diaper included an outercover with a breathability of 885 MOCON. The second more breathable diaper included an outer cover with a breathability of 9055 MOCON. And, the third and most breathable diaper included an outercover with a breathability of 14,460 MOCON. Twenty test subjects participated in the arm-band TEWL study. Diapers were applied to the arm and three insults of 70 mls of saline solution at a rate of 300 ml/min were applied at 45 second apart. The test subjects wore the armbands for 60 minutes and baseline and final TEWL readings were completed using the Dermalab Evaporimeter. Averages of the test results are provided in Table 2 below.

TABLE 2
Skin Hydration Value As Measured By TEWL of Diaper Constructions
Versus Control Examples

| | OUTER COVER BREATHABILITY | | |
|---|---|---|---|
| | 855 | 9055 | 14,460 |
| CONTROL | MOCON | MOCON | MOCON |
| EXAMPLES | WVTR | WVTR | WVTR |
| w/conventionally | 40.3 g/m²/hour | 26.4 g/m²/hour | 25.9 g/m²/hour |
| treated surge layer | | | |
| w/EHEC treated | 36.3 g/m²/hour | 22.0 g/m²/hour | 18.9 g/m²/hour |
| surge layer | | | |

The diapers that included a surge layer in which fibers had been treated with BERMOCOLL EBS E481 FQ (“EHEC”) showed significant decreased humidity as measured by TEWL improvement versus diapers that included conventionally treated surge layers. The amount of vapor in the wet diaper environment decreased by 4 g/m²/hour in the low breathabilty diaper example and decreased by 7 g/m²/hour in the high breathabilty diaper example.

Diapers that included a surge layer containing EHEC-treated fibers showed improved dryness as exhibited by a consistent reduction in TEWL values of 4-6 points compared to diapers containing a similar bonded carded surge layer that was treated with a conventional surfactant system. The bonded carded surge layer in the conventional HUGGIES Supreme diaper was treated with a blend of ethoxylated, hydrogenated castor oil and sorbitan monooleate along with processing aids such as lubricant and anti-static agents.

Additionally, another example 4 was prepared that included a single-layer, bonded carded web having a basis weight of 2.5 osy formed from a 60:40 blend of 1.5 denier bicomponent staple fibers pretreated with an aqueous 0.10 percent by weight solution of EHEC at an add-on level of about 0.1 weight percent of EHEC on the finished bicomponent fibers and 6 denier PET staple fibers pretreated with a 0.55 weight percent solution of a blend of ethoxylated, hydrogenated castor oil and sorbitan monooleate at an add-on level of 0.55 weight percent of ethoxylated, hydrogenated castor oil and sorbitan monooleate on the finished PET fibers. The bonded carded web was then inserted between the body-side liner and the absorbent core of a HUGGIES Ultratrim Size 4 diaper to replace the previous surge layer. The body-side liner was also replaced with a 0.5 osy, 2.7 dpf polypropylene (Exxon PP 3155) spunbonded fabric treated according to the process described in Examples 1-3 above. The combination was then tested on human subjects for TransEpidermal Water Loss using the test procedure detailed above. Diapers were applied to the arm and three insults of 70 mls of saline solution at a rate of 300 ml/min were applied at 45 second apart. The test subjects wore the armbands for 60 minutes and baseline and final TEWL readings were completed using the Dermalab Evaporimeter. Averages of the test results indicated a TEWL value of 27.71 g/m²/hour.

### Example 5

Example 5 was a treated sample as described in Example 2 which included a petrolatum-based skin health composition toward the skin of a wearer on the treated spunbond liner material. TEWL tests were conducted as described above and TEWL was measured at 25.63 g/m²/hour. Identical product without the skin health agent applied to the material indicated a TEWL measurement of 25.63 g/m²/hour. This indicates TEWL is predominately controlled by the sided treatment.

### Example 6

Example 6 was treated with the EHEC on the top side of the bonded carded web inserted between the body-side liner and the absorbent core of a HIGGIES Ultratrim Size 4 diaper to replace the previous surge layer and TEWL tested as described above. Averages of the TEWL testing indicated a TEWL average value of 25.69 g/m²/hour.

### Example 7

Example 7 describes the bonded carded web treated throughout the bulk of the material and inserted as described in Example 6. TEWL testing indicated an average result of 24.41 g/m²/hour.

### Example 8

Example 8 contains a bonded carded web material as described in Examples 5 and 6 however; the addition EHEC treatment is excluded. TEWL testing as described above indicated an averaged result of 28.34 g/m²/hour.

Although various embodiments of the invention have been described above using specific terms, devices, and methods, such description is for illustrative purposes only. The words used are words of description rather than of limitation. It is to be understood that changes and variations may be made by those of ordinary skill in the art without departing from the spirit or scope of the present invention, which is set forth in the following claims. In addition, it should be understood that aspects of the various embodiments may be interchanged both in whole or in part. Therefore, the spirit and scope of the appended claims should not be limited to the description of the preferred versions contained therein.

1. A porous, treated substrate comprising a first surface that comprises a first amount of a surfactant or mixture of surfactants and a second surface that comprises a second amount of the surfactant or the mixture of surfactants wherein the second amount of the surfactant or the mixture of surfactants on the second surface is less than the first amount of the surfactant or the mixture of surfactants on the first surface.

2. The porous, treated substrate of claim 1 wherein the porous, treated substrate is a single layer.

3. The porous, treated substrate of claim 1 wherein the porous, treated substrate is a thermoplastic porous, treated substrate and the thermoplastic is selected from the group consisting of polyolefins, polymers and copolymers of ethylene, polymers and copolymers of propylene and combinations thereof.

4. The porous, treated substrate of claim 1 wherein the porous, treated substrate is a film, a nonwoven fabric or a foam.

5. The porous, treated substrate of claim 1 wherein the porous, treated substrate is a single layer of film, a single layer of nonwoven fabric or a single layer of foam.

6. The porous, treated substrate of claim 1 wherein the porous substrate is a single layer of spunbond nonwoven fabric that has a basis weight ranging from about 10 grams per square meter to about 50 grams per square meter.

7. The porous, treated substrate of claim 1 wherein the surfactant or the mixture of surfactants is selected from the group consisting of ethoxylated, hydrogenated castor oil; sorbitan monooleate; ethoxylated polyalkyl siloxanes; an alkyl polyglycosides, derivatives of an alkyl polyglycosides and mixtures thereof.

8. The porous, treated substrate of claim 1 wherein surfactant or the mixture of surfactants comprises an ethoxylated, hydrogenated castor oil; sorbitan monooleate; and an alkyl polyglycoside or a derivative of an alkyl polyglycosides

9. The porous, treated substrate of claim 1 wherein the first surface comprises at least about 0.18 weight percent of the surfactant or the mixture of surfactants and the second surface comprises less than about 0.15 weight percent of the surfactant or the mixture of surfactants.

10. The porous, treated substrate of claim 1 wherein the first surface comprises at least about 0.5 weight percent of the surfactant or the mixture of surfactants and the second surface comprises less than about 0.01 weight percent of the surfactant or the mixture of surfactants.

11. The porous, treated substrate of claim 1 wherein the second surface comprises essentially no surfactant.

12. The porous, treated substrate of claim 1 wherein the second surface comprises no surfactant.

13. A personal care absorbent article comprising a liner that comprises the porous, treated substrate of claim 1.

14. A diaper comprising a liner that comprises the porous, treated substrate of claim 1.

15. A method of treating a porous substrate, the method comprising:
a. providing a porous substrate, the porous substrate having a first surface and a second surface; and
b. contacting a surfactant or a mixture of surfactants to the first surface of the porous substrate such that a lesser amount of the surfactant or mixture of surfactants contacts the second surface than contacts the first surface.

16. The method of claim 15, wherein the method results in less surfactant adhering to the second surface relative to the first surface.

17. The method of claim 15, wherein the step of contacting a surfactant or a mixture of surfactants to the first surface of the porous substrate comprises contacting a foam that comprises the surfactant or mixture of surfactants to the first surface.

18. The method of claim 15, wherein the step of contacting a surfactant or a mixture of surfactants to the first surface of the porous substrate comprises contacting a foam that comprises air and a liquid comprising the surfactant or mixture of surfactants to the first surface, wherein the ratio of the air volume to the liquid volume of the foam is not greater than about 30 to 1.

19. The method of claim 15, wherein the step of contacting a surfactant or a mixture of surfactants to the first surface of the porous substrate comprises contacting an aqueous solution, dispersion or emulsion that comprises greater than about 10 weight percent of the surfactant or mixture of surfactants.

20. The method of claim 15, wherein the step of contacting a surfactant or a mixture of surfactants to the first surface of the porous substrate comprises contacting the porous substrate with an aqueous solution, dispersion or emulsion at a rate of less than about 0.5 weight percent of the aqueous solution, dispersion or emulsion comprising the surfactant or mixture of surfactants relative to the weight of the porous substrate.

21. The method of claim 15, wherein the step of contacting a surfactant or a mixture of surfactants to the first surface of the porous substrate comprises contacting an aqueous solution, dispersion or emulsion of the surfactant or mixture of surfactants wherein the aqueous solution, dispersion or emulsion of the surfactant or mixture of surfactants comprises not less about 15 weight percent of the surfactant or a mixture of surfactants.

22. The method of claim 15, further comprising providing the porous substrate in a first direction, bending the porous substrate in a second direction around an apparatus to define a wrap angle of from about 90° to 180° and contacting the surfactant or mixture of surfactants to the first surface of the porous substrate at about the point the porous substrate bends around the apparatus.

23. The method of claim 15, further comprising providing the porous substrate in a first direction, bending the porous substrate in a second direction around an apparatus to define a wrap angle of from about 120° to 180° and contacting the surfactant or mixture of surfactants to the first surface of the porous substrate at about the point the porous substrate bends around the apparatus.

24. The method of claim 15, further comprising providing the porous substrate in a first direction, bending the porous substrate in a second direction around an apparatus to define a wrap angle of from about 150° to about 170° and contacting the surfactant or mixture of surfactants to the first surface of the porous substrate at about the point the porous substrate bends around the apparatus.

25. The method of claim 14, further comprising drying the porous, treated substrate by directing a gas at the substrate in a direction that is generally from the second surface toward the first surface.

26. The method of claim 14 further comprising drying the porous, treated substrate by directing heated air at the porous treated substrate in a direction that is generally from the second surface toward the first surface.
